(19) United States
(12) Patent Application Publication
(10) Pub. No.: US 2003/0078856 A1
(43) Pub. Date: Apr. 24, 2003

(54) Book preview advertising system for online booksellers

(76) Inventor: Jihan Zubi, Bremerton, WA (US)

Correspondence Address: AL HARRISON, 1018 PRESTON STREET, SUITE 100, HOUSTON, TX, 77002, US

(21) Appl. No.: 10/241,552

(22) Filed: Sep. 11, 2002

Related U.S. Application Data
(60) Provisional application No. 60/318,946, filed on Sep. 11, 2001.

(51) Int. Cl. G06F 17/60; H04N 7/173

(52) U.S. Cl. 705/26; 705/14; 725/109; 725/110

(57) ABSTRACT

A Book Preview advertising system using primarily a visual Book Preview format and that is targeted to selling books online based on customer psychographical and behavioral profiles. The Book Preview is a short duration advertisement featuring author and publisher perspectives rather than reader or customer perspectives. This visual Book Preview presentation is formatted similar to a short film, having a beginning, a climax, and a conclusion. Once a customer selects an appropriate title of a book or a genre of books from an online bookseller's website, the customer is then prompted to view the corresponding Book Preview. When such viewings occur for cumulated customers, suitable book order quantities may be calculated from corresponding hits. Using cumulated browsing customer demographics, advertisements may also be shown to selected customers. A link to this Book Preview may be placed at designated intervals and is appended to appropriate Web site pages; this link may then take customers to another Web site to view a visual Book Preview.

### RELATED APPLICATIONS

This application claims priority based upon Provisional U.S. Application Ser. No. 60/318,946 filed Sep. 11, 2001.

### FIELD OF THE INVENTION

The present invention relates to a methodology for online booksellers to advertise books, and more particularly, relates to a methodology for enabling online booksellers to automatically register customers' interest in particular books and for concomitantly tracking the amount of Book Preview viewings, thereby providing a precise measure of such customers' interest in particular books or categories of books.

### BACKGROUND OF THE INVENTION

In the developing field of online commerce in which merchants conduct business through the use of Web sites and concomitant email communications with current and prospective customers, it is well known that such online merchants market their products and services using techniques including banner advertisements, pop-up advertisements, editorials, and customer feedback. As will be understood by those skilled in the art, these advertising techniques not only promote customers' interest in such products and services, but also provide merchants insight into appropriate intervals for placing these advertisements.

The personalized nature of these advertisements relative to particular users may sometimes rely upon a merchant company database that stores information targeting these users. As will be understood by those skilled in the art, a company using such marketing databases seeks to match customers' interests with exposure to suitable advertisements. The company then tracks the number of hits received by particular products and determines the overall customer interest in these products. As is well known in the art, online booksellers advertise books in a variety of ways including banner advertisements, pop-up advertisements, editorials, customer feedback, online catalogs, mail-order catalogs, and links from other sites.

Typically, these links implicate an associate or partnership relationship between the source, i.e., linking, site and the target, i.e., linked, site. An example of an associate or partnership relationship is the Associates Program that is operated under the auspices of Amazon.com. It will be appreciated by those skilled in the art that an inherent limitation of such prevalent online advertising is that customers do not interact in the same manner as is common for customers visiting at regular brick-and-motor commercial bookstores. Besides having the opportunity to touch (hardback) books and to read the biased commentary and critical analysis contained on inside covers and jackets, customers are exposed to related hardcopy newspaper and magazine advertisements. Accordingly, there is only a chance that an online customer will read an editorial associated with a book to help the customer decide whether to engage in a buy-transaction.

Another problem common in the art is the very limited time expended by customers who are browsing through book titles online. Indeed, oftentimes, such browsing customers become bored and are easily distracted while reading typically tedious editorials and reviews. As will be appreciated by those skilled in the art, customers prefer an experience in which online booksellers seem to be more in tune with contemporary Internet culture and protocol: customers prefer to partake of expeditious point-and-click transactions.

Other limitations of the prior art is that customers typically fail to receive the benefit of having an accurate and direct glimpse of authors' insights and the like into motives for writing books, or of publishers' motives for publishing specific books. Unfortunately, based upon conventions commonly used in the art, customers' exposure to these motivational issues is obtained only second-hand through hyperbolic acclaim that is generally manifest in other, supplemental publications via the feedback engendered by critics, reviewers, and the like. Ironically, it is typical for customers to receive this kind of feedback about books through published editorials, but, unfortunately, the authors' perspective is discreetly omitted. It should be obvious to those skilled in the art that second-hand perspectives afford inadequate intimate views of the source of authors' inspiration for writing books. Similarly, it should be obvious to those skilled in the art that second-hand perspectives obtained from reading editorials or the like afford inadequate intimate views of the circumstances involving publishers' commercializing books. On the contrary, instead of customers reading through editorials written by book reviewers or the like, customers may acquire first-hand book perspectives directly from book authors or publishers, per se.

Accordingly, these limitations and disadvantages of the prior art are overcome with the present invention, and improved means and techniques are provided which are useful for developing and including Book Preview advertising for online booksellers. It has also been found that, in view of more and more books being made into feature films, the present invention is particularly useful for enabling movie producers and the like to apply the Book Preview taught by the present invention to provide a more advanced methodology than has been known in the art for viewing more book plots than would be otherwise feasible by the conventional approach of movie producers simply reading through books. Thus, the Book Preview Web site contemplated by the present invention would enable movie producers to become conversant with book content via their own formats. It is advantageous that limitations of tedious editorials have been overcome by movie producers and the like having the ability to view more Book Previews per unit time than has been heretofore known.

### SUMMARY OF THE INVENTION

The present invention teaches a system for utilizing Book Previews constituting visual, moving advertisements as a means of informing and enticing prospective book customers to purchase a diversity of literary products via an online computer system such as is enabled by a global computer network such as the Internet or via similar corporate intranets or the like. By enabling book customers to view the Book Previews contemplated by the present invention, it has been found that book customers tend to view more previews than would otherwise be read in a given time frame.

An important ingredient of such a Book Preview system is to present a book in a visual manner with a concomitant concise accounting of the book's attributes. As will become clear to those skilled in the art, the structure of the Book Preview methodology taught by the present invention not limited to enabling viewing customers to become conversant with the book's storyline. Indeed, in addition to the book's storyline, the Book Preview of the present invention delivers to customers a first-hand perspectives of the book's contents preferably from the vantage points of both the author and the publisher.

It will be appreciated that this Book Preview advertising methodology may be implemented via the Internet or other computer-networked environment that may be exploited by online booksellers. These online booksellers seek to provide less time-consuming and more customer-friendly marketing materials to a plurality of browser-perusing customers. In addition, this methodology enables online booksellers to more effectively predict book-customer interest and book-buyer behavior. Thus, it will become evident that online booksellers would utilize the Book Preview methodology to account for the extent of book customer interest through hits of Web site content including specific book icons or other book indicia, corresponding to particular Book Previews. These techniques, of course, enable booksellers to analyze the customer interest and to then make educated estimates of book inventory that is commensurate with demand therefor.

It will be appreciated that Book Previews implemented and presented online according to the preferred embodiment would be available online on a plurality of Web sites with a relatively large set of books which fall within a relatively small set of book categories. For example, if there were 30 categories of books, there would be available Book Previews for all of the books that fall under any and all of the specific categories. It will be understood that the plurality of books that would be rated most aggressively would correspond to the books that have already been previewed by a substantial customer audience. These books may hail from so-called “best-seller” lists obtained from local and national newspapers, local and national magazines, and from impending booklists from any other publication. It is contemplated that these books would correspond to the most important of the rated books.

Another aspect of the present invention is to preferably provide a Book Preview for virtually each of the plurality of available books offered by a book vendor or the like. It has been found that exposure to such extensive visual previews tends to avoid frustrating customers who are enjoying the Book Preview experience contemplated by the present invention. It is also contemplated that online booksellers would tend to subscribe to the teachings of the present invention, thereby tending to increase the application of Book Previews to available books. That is, as the advantages of the instant advertising methodology are clearly demonstrated to booksellers based upon short response times between book customer viewing and consequent book purchases. It also will be readily understood that embodiments of the present invention tend to eliminate conventional delays between customer exposure to conventional book reviews and customer ratings of purchased books. Ergo, it is another advantage of the present invention that there are virtually no appreciable delays between customer exposure to Book Previews and corresponding customer rating of purchased books.

It will be appreciated by those skilled in the art that, as customers acquire an appreciation for advances in technology that promote the online browsing and purchasing experience, these customers tend to tolerate only expedited purchase transactions. It is interesting to note that the majority of customers who browse products online without making a purchase are under the age of 35 years old. Apparently, these customers, being tuned into the current state of technology, do not have the patience or time or interest to view a plurality of book reviews or the like before making a purchase decision. Indeed, frequently, customers under age 35 seem to just browse Web sites to find information about products as a precursor to embarking on actual trips to a local brick-and-mortar bookstore.

It is contemplated by the present invention that these customers—generally under age 35—are among the targeted customers who would rather invoke an online visual Book Preview that constitutes a synergy of easy, convenient, entertaining, and a time-efficient way to shop online. It will be appreciated that even in a conventional brick-and-mortar bookstore, book customers are usually tempted to read book jackets of many books in a few categories rather than to read about particular book reviews and then to immediately buy the corresponding (reviewed) books.

Thus, it is a feature and advantage of the present invention, that, just as book buyers predictably tend to read book jackets at conventional bookstores, visually-flavored Book Previews taught by the present invention would tend to provide somewhat analogous and, indeed, superior means for book buyers to, in effect, view contents of virtual book jackets. Thus, such virtual book jackets or online Book Previews allow customers to have the benefit of a more intimate experience via an online bookstore because it enables an accurate manifestation to be dynamically experienced first-hand, sharing the attitudes and insights of the relevant authors and publishers. Hence, such online book customers have been exposed directly to an author's perspective and interpretation of a book, and directly to a publisher's insights into and rationale for publishing the book, and, accordingly, would tend to feel more comfortable browsing the Book Preview rather than just relying on a second-hand recommendation from an editor or reviewer or the like, with whom obviously no relationship exists. Moreover, as will be readily appreciated by those skilled in the art, this latter, conventional approach is devoid of any concept or understanding of customers' tastes or preferences.

For example, consider an architect who knows nothing about seafaring. After reading a book about seafaring, the architect might portray the book as being “the most hideous book on earth.” This review is clearly based upon limited knowledge and background, and, of course, is based upon absolutely no appreciation for seafaring, per se. As another perhaps less extreme example, while editors typically have read extensively on a diversity of subjects, such editors must be blessed with substantial knowledge of all pertinent styles and methodologies in order to appreciate and critique applicable literary works. It will be readily understood by those skilled in the art that most editors are unable to fully appreciate and to properly critique such literary works because the prerequisite knowledge and experience involving such diversity of subject matter and literary concentration is rarely afforded by editors.

It will also be understood that most editors employed for book reviews and the like are inadequately screened for the purposes contemplated by the present invention. From a practical vantage point, there is actually no way to screen editors completely. It is well known in the art that editors are typically chosen based upon submitted writing samples. Inherently overcoming this prevalent deficiency in the art, the Book Previews of the present invention would allow a more generally concrete and representative way to communicate the essence of a book: emulating the conventional way that brick-and-mortar book browsers read book back jackets. Similarly, embodiments of the present invention enable online book browsers to view virtual book covers or the like.

In a preferred embodiment, the Book Preview icon taught by the present invention would be placed near the picture of the book itself on an online bookseller's Web site. When a customer presses on the icon, thereby invoking the function represented by the icon or the like, a link is immediately triggered to the corresponding Book Preview Web site and commences playing the virtual visual book cover. Then, after viewing the preview—in its entirety or only in part—the customer has the option to buy the book, to view another Book Preview from the site's database, return to the bookseller's site, or terminate the online browsing experience. In a manner well known in the art, if the option to buy the book is selected, the customer will be returned to the online bookseller's site for effectuating a book-buy transaction.

If the option to view another virtual Book Preview is selected, the customer will be preferably presented with pull-up menu or the like that includes all of the available Book Preview genres that are stored in the underlying database. In a manner well known in the art, the customer would then click on an appropriate book genre category and then would be presented with a menu showing all of the titles in the selected genre in the database. As hereinbefore described, a customer clicking on a particular book title icon invokes the corresponding Book Preview.

Commensurate with advertising techniques commonly used in the art, it is contemplated under embodiments of the present invention that, to promote the visibility of Book Previews, online booksellers would judiciously emplace Book Preview icons on the Homepage or the like. Such icons would, of course, direct customers to the plurality of Web sites that are integrated with the repository of Book Previews. It will be evident that marketing tools such as banners could be optimally positioned on related and partnered Web sites to broaden the reach of bookseller advertising. It will be appreciated by those skilled in the art that Book Previews of the present invention may also be virtually housed on a publisher's or an author's own Website, if advantageous.

Another aspect of the present invention is that contemplated visual Book Previews would ebable online booksellers to produce a CD Catalog—available online or offline—designed to advertise the newly published books or any variety of books. Such a CD Catalog would preferably be distributed to customers who have previously made purchase orders. For example, after a customer purchases a book online, the book would arrive along with a complimentary CD Catalog containing a plurality of visual Book Previews preferably pertaining expressly to genre categories closely tailored to the particular customer's interest manifest in a user profile database or the like. As another example, such a CD Catalog fraught with visual Book Previews would be used to provide focused advertising for distribution during holiday peak times or their optimally targeted dates or special occasions.

Thus, contemporaneously with Lance Armstrong winning his fourth consecutive Tour de France, a CD Catalog containing visual Book Previews about cycling books could be distributed to customers who have manifest inertest in the sport of cycling. Of course, since the Lance Armstrong scenario also implicates overcoming serious health challenges from cancer and the like, an embodiment of this market C9/11/2002 Catalog could include visual Book Previews pertaining to both books about battling diseases and health conditions, and to books generally addressing health and fitness issues. Targeted customers who receive such a focused CD could either deem the CD to be junk-mail and toss it, could invoke and browse the Book Previews only pertaining to cycling books, could invoke and browse the Book Previews only pertaining to books about battling diseases and health conditions, could invoke and browse the Book Previews only pertaining to books addressing health and fitness issues, or could invoke and browse a combination of Book Previews from these various genres. Diametrically opposed to distribution of a focused CD Catalog, using the teachings of the present invention, online booksellers could compile a variety of Book Previews and corresponding booklets in CD format for distribution generally to prospective buyers, including any customers who have historically purchased books from the bookseller.

These and other objects and features of the present invention will become apparent from the following detailed description, wherein reference is made to the figures in the accompanying drawings.

### IN THE DRAWINGS

FIG. 1 depicts a system flow diagram of the visual Book Preview methodology according to the preferred embodiment of the present invention.

FIG. 2 depicts a simplified overview of the construction of e visual content contained within a Book Preview of the present invention.

FIG. 3 depicts a typical interaction of an online book customer with the preferred embodiment of the present invention implemented on an online bookseller's Web site.

FIG. 4 depicts how a bookseller such as Amazon.com would use the present invention to calculate customer interest in a particular book and then estimate future book orders.

FIG. 5 depicts an illustrative format for a visual Book Preview of the present invention, using Ayn Rand's The Virtue of Selfishness.

FIG. 6 depicts a sample screen layout of an online bookseller's Web site wherein visual Book Previews may be invoked and viewed by customers.

### DETAILED DESCRIPTION

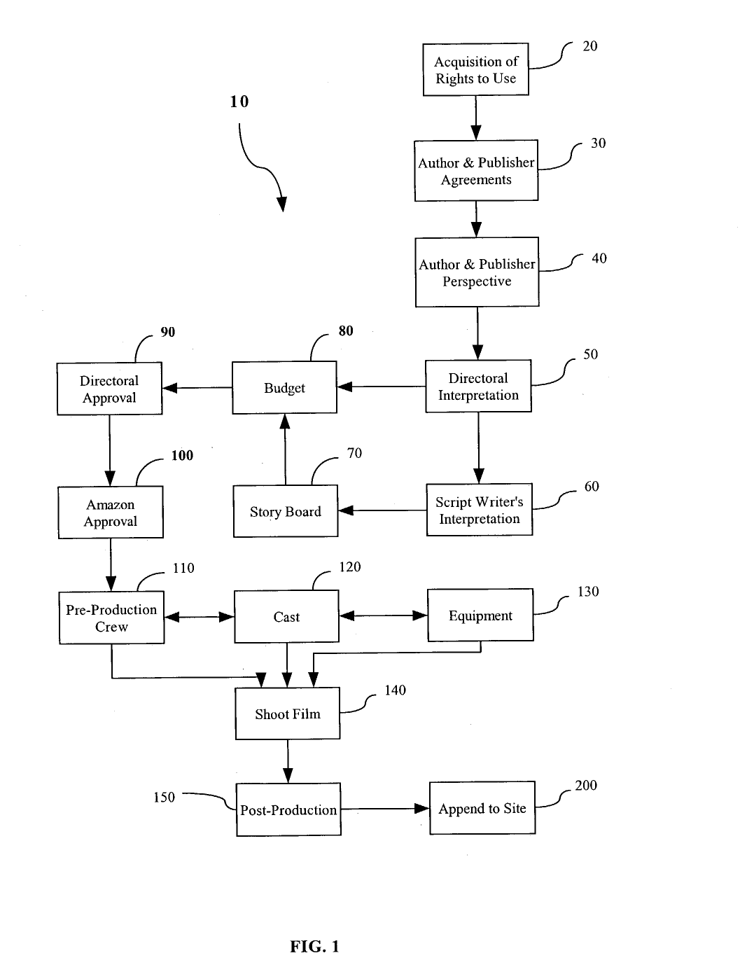

Referring collectively to FIGS. 1-6, there are depicted representations of the preferred embodiment of the present invention. For illustrative purposes, the preferred embodiment is described in terms of an implementation on the Web site of popular online bookseller Amazon.com. It should be clearly understood that, although the present invention is described in terms of visual Book Previews, the visual previews contemplated hereunder are also applicable to advertising methodology for other products and services including movies, magazines, journals, newspapers, and any other product and service available for purchase from merchants or vendors online.

It is well known in the art that the amazon.com Web site provides a variety of services for allowing customers to browse particular sites and then, if applicable, to make purchases from Amazon's numerous book titles and the like. As will be appreciated by those skilled in the art, to promote online marketing of available books and other products and services, Amazon provides customers access to an editorial service and to a database of reader feedback and recommendations. Nevertheless, in spite of its attempts to effectively market books and the like online, the Amazon.com site fails to enable customers to experience a visual advertising system taught by the present invention. The methodology delivered by systemic embodiments of the present invention is described in detail herein in the context of a visual Book Preview.

Now referring to FIG. 1, there is depicted a system flow diagram of advertising methodology 10 for producing a visual Book Preview in accordance with the preferred embodiment of the present invention. As will become evident to those skilled the art, FIG. 1 illustrates the stepwise implementation of a system that produces a visual Book Preview video designed to be subsumed into the structure of an online bookseller Web site.

Thus, after an online bookseller or publisher chooses a book to market via the Web, in block 20, the rights to use the content of the book in the visual Book Preview are sought. Then, in block 30, an acquisition agreement for these rights is preferably negotiated and consummated with the publisher and the author. As will be appreciated by those skilled in the art, this acquisition agreement should preferably also encompass the parameters of production. This agreement authorizes the nature and extent of the content that will be incorporated into the Book Preview, and endeavors to prevent intellectual property liability lodged by the author, the publisher, or a party related to either of the author or the publisher.

Next, in block 40, the person designated to prepare the factual basis for the Book Preview interviews preferably both the author and the publisher. Of course, while this interviewer will be designated by the Book Preview producer or director, the interviewing task may fall upon the shoulders of the producer or director, depicted as block 50. It is contemplated under the preferred embodiment, in block 60, that the writers of the Book Preview will actually conduct this interview in order to acquire an accurate, first-hand perspective and elemental montage of the background for the creation and publication of the book. As will become evident to those conversant in the art, it is intended under the present invention that a customer will be subjected to a short, active visual Book Preview that captures the personality and style communicated by the combination of author and publisher manifest in the related book.

Still referring to FIG. 1, as depicted in block 70, an overall interpretation and authorized implementation of the book will then be story boarded. As is well known in the art, story boarding comprises a process in which drawings are laid out in sequential order and effectively represent the requirements for the prerequisite plurality of moving images. Then, depicted in block 80, a budget is prepared for the duration of production, including pre- and post-production. After the directorial approval, block 90, and bookseller approval, block 100, are granted, production ready to start.

A production manager, preferably one that works in-house, is hired. As shown in block 110, the production manager hires a suitable crew to perform casting, pre-production and post-production. The production manager, as depicted in block 130, also orchestrates acquisition of the prerequisite video equipment. As depicted by block 120, the casting crew schedules auditions and selects the cast. Then, the production time-line is prepared and shooting locations are established. The shooting schedule is begun and, of course, is conducted until production is complete, as represented by block 140. Next, as represented by block 150, as contemplated by the present invention, the visual Book Preview is garnered with special effects, edited, etc., in post-production. Finally, when the visual Book Preview is completed, it will be appended to the appropriate bookseller Web site, as shown in block 200.

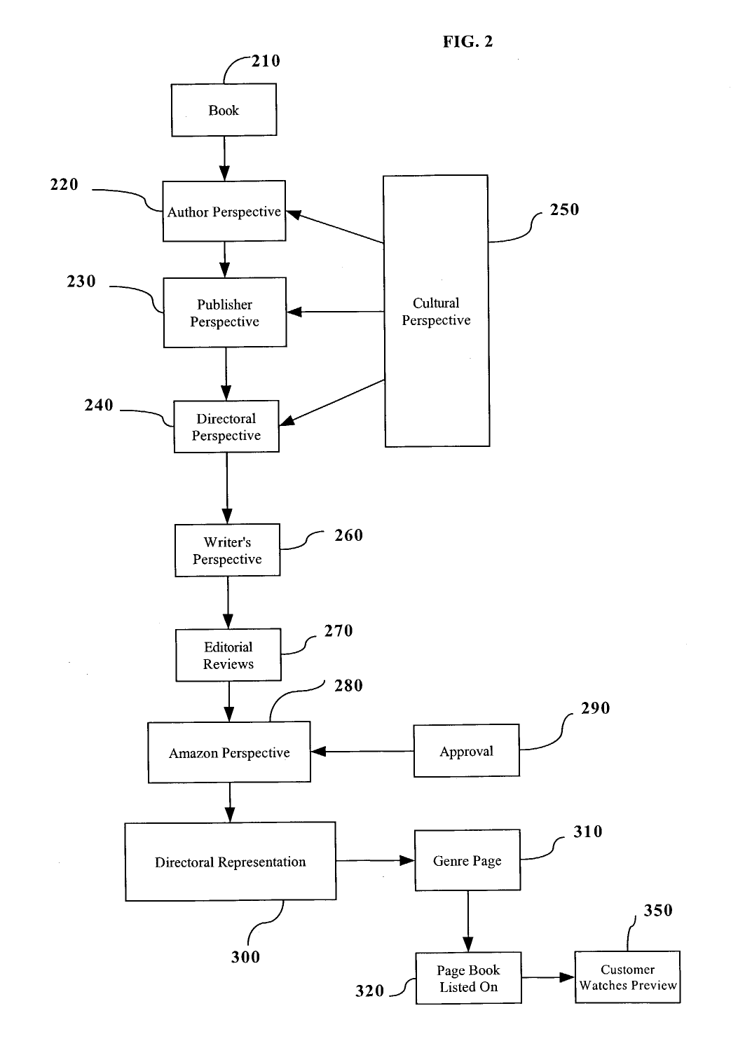

Now referring to FIG. 2, there is depicted a simplified overview of the construction of the visual content contained with a Book Preview of the present invention. Those skilled in the art will appreciate the manner in which textual content is subsumed into the visual Book Preview taught herein. With the perspective of the book's author 220 as the focal point of what the visual Book Preview will emphasize, there is a synergistic confluence of the author perspective 220 with both the publisher perspective 230 and the director perspective 240 to produce what is called the “cultural perspective” 250. According to the present invention, each of the author, publisher, and director, in turn, elaborate on the contents of the book in order to reveal realistic and accurate insight into the nature of the book.

It will be understood that the present invention enables the book's cultural perspective to feed the prospective book buyer's perspective in a manner hereinbefore unknown in the art. A book's cultural perspective as contemplated under the present invention may be envisioned in a demographic sense: the perceived audience of a particular book devolves to a plurality of customers targeted by each of the book's author and publisher, and the Book Preview director. All three seek to communicate a unique and intertwined message to the perceived customer audience. That is, even though author, publisher, and director typically have different perspectives, these perspectives are not independent of each other. Obviously each of these interdependent perspectives pertains to the same book.

Still referring to FIG. 2, after deciding on the appropriate framework for the visual Book Preview, the director assigns a writer or team of writers 260 to write the script for the Book Preview. Besides writing the script, the plurality of writers will collaborate with the editorial staff 270 to assure that the Book Preview meets the director-assigned requirements and specifications. After the entire Book Preview is approved by the director 290, it is then assigned to the online bookseller 280 to approve or disapprove the content for inclusion on the appropriate genre Web page 310. The corresponding visual Book Preview page is then listed and displayed to the customer for browsing as hereinbefore described.

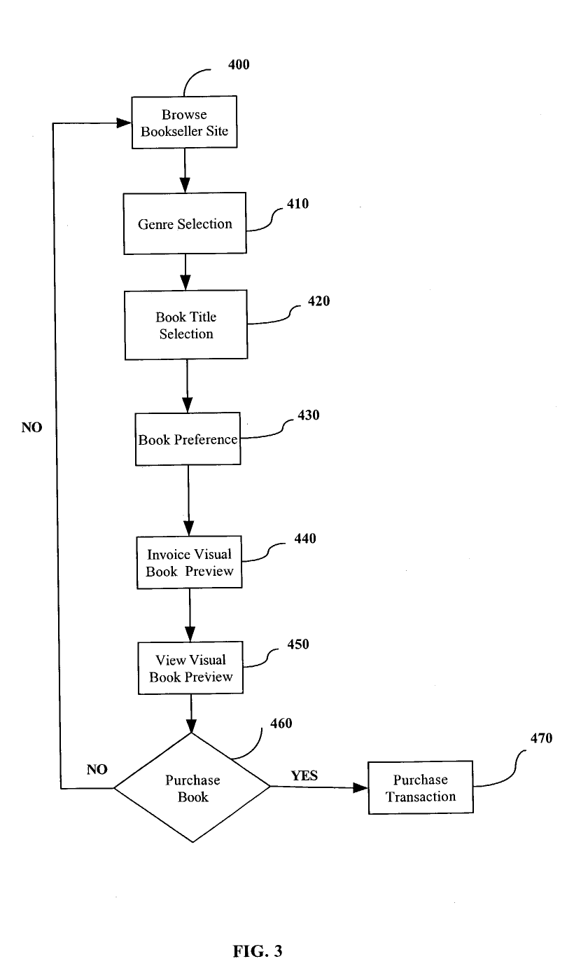

Referring now to FIG. 3, there is shown a typical interaction of an online book customer with the preferred embodiment of the present invention implemented on an online bookseller's Web site. First, in block 400, the customer, as a perspective book buyer, browses the bookseller Web site and, in block 410, chooses the genre of books being sought. Thus, a customer might specify such genres as science fiction or cooking. Then, in block 420, the customer views the available inventory of books, preferably presented in the form of an easily recognizable menu. It will be clearly understood that, regardless of the nature of the display of the available books satisfying the customer's selected genre, the customer must invoke the book title of interest, in block 430, either by a mouse-click or like action commonly used in the art. The customer is then, in block 440, routed to a Web site that contains the appropriate player for the Book Preview video, shown in block 450. Either at the end of this viewing of the Book Preview or sometime during the viewing, the customer chooses, in block 460, whether to purchase the book, to watch another Book Preview, or to return to the bookseller site to browse other genres and more book titles. If the customer elects to purchase the book, then the purchase transition is triggered in block 470.

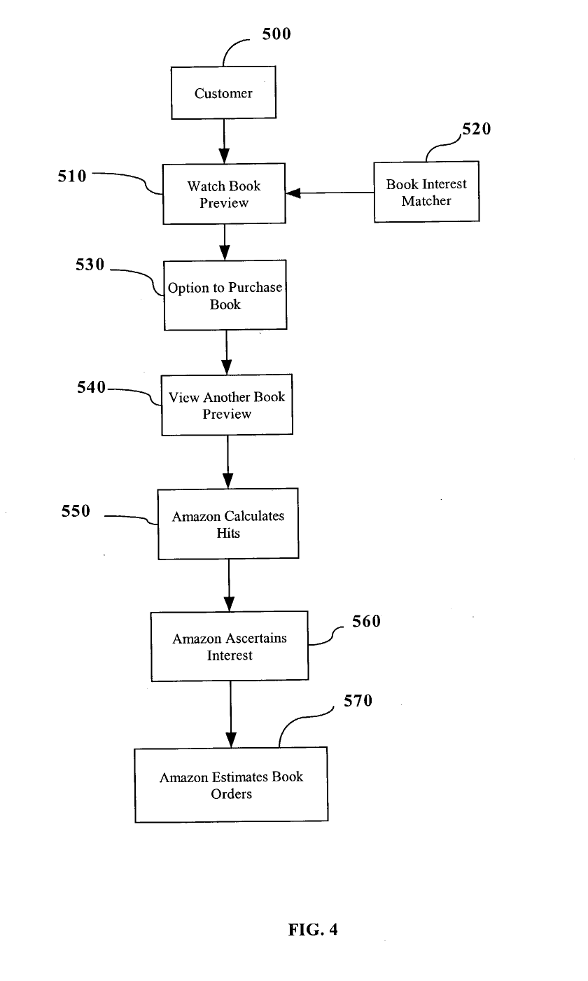

FIG. 4 depicts how a bookseller such as Amazon.com would use the present invention to calculate the appropriate interest in a particular book and, more appropriately, analyze how many books are apt to be ordered in the future. When a customer 500 views a visual Book Preview 510, the customer's interests matched using a database 520 such as “Book Matcher” used by online bookseller Amazon. As will be appreciated by those skilled in the art, this matching or comparison step seeks to correlate a particular customer's preference behavior with a knowledge base of accumulated customers' preference behavior pertaining to the product being entertained, e.g. books. From this correlation, an online bookseller may make calculations 550 to estimate book inventory to satisfy customer demand. The customer, of course, is afforded the option to purchase the book 530 or may opt to view another Book Preview 540.

It will be appreciated that, if there were significantly more viewing of visual Book Previews than there are orders for the book, consumer interest in the book 560 would be deemed to be minimal wherein a small inventory would be indicated, since only low-volume orders would be anticipated. On the other hand, if these purchase orders are substantially commensurate with the Book Preview viewings, consumer interest in the book 60 would be deemed to be high wherein a large inventory would be indicated, since high-volume orders would be anticipated. Of course, it is a feature and advantage of the present invention that, even if book purchases have not been effectuated, if there exists customer propensity for viewing a particular visual Book Preview, the amount of hits indicates interest in the corresponding book. This calculation 550 could be used to tally the interest in a particular book. The present invention contemplates that an analysis may ensue inquiring into the reason that the book has failed to sell when there is substantial interest.

It will be appreciated that the visual Book Preview system of the present invention does not only apply to new books or to best sellers available on a bookseller Web site, but also applies to all genres irregardless of the publication date. It is thus valuable to online booksellers to provide an accurate and exciting visual preview of books that foster customer interest and that ultimately will engender online sales. Another important advantage of the present invention is to enable the creation of current, accurate, and more wholesome customer profiles in order to maximize accumulated browser information that feeds the book inventory equation and advertising strategies.

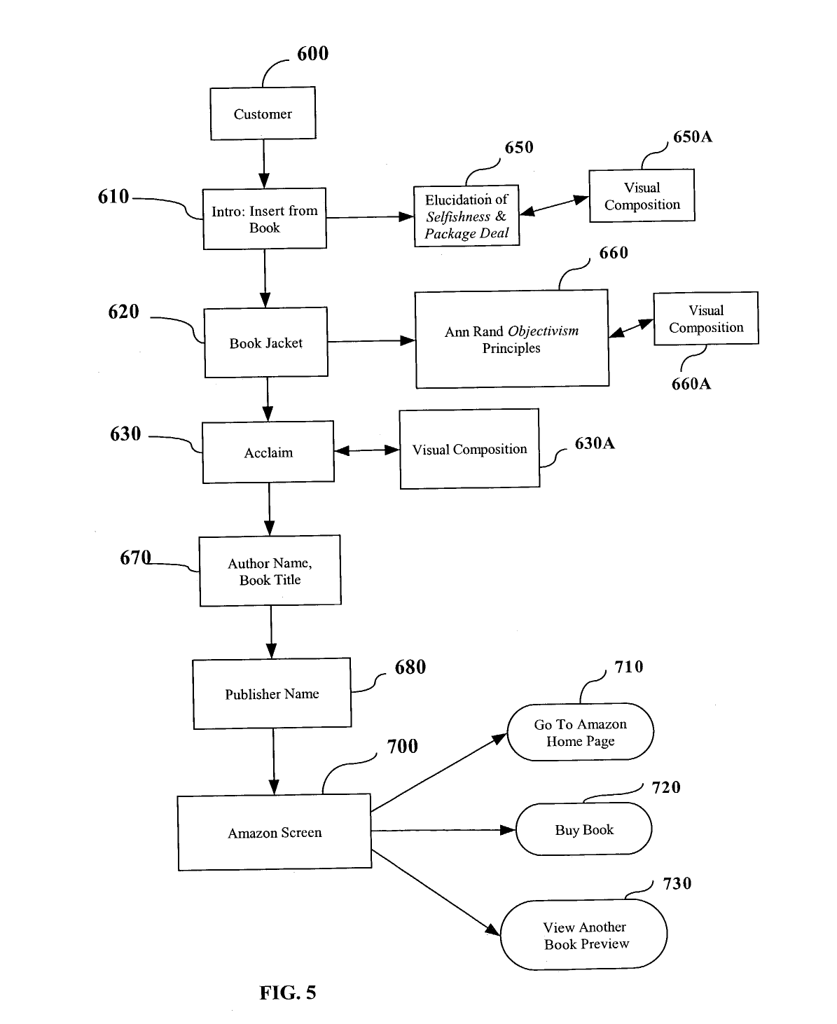

FIG. 5 depicts an illustrative format for a visual Book Preview of the present invention. It should be appreciated that this illustration emphasizes the extraction of the book jacket and excerpts from the book that are integral to the visual, commercial medium of the Book Preview methodology of the present invention. In the example, Ayn Rand's book entitled The Virtue of Selfishness 600 is used. The introductory elemental and textual content 610 is reproduced from the book's jacket 620 and combined with the appropriate visuals 630 that derive from the hereinbefore described interview process, wherein each of the author and the publisher have preferably been interviewed by the producer and the director. It will be seen that, in the introduction, there is an insert of the book 650 that proclaims its basic and most understandable premise.

In the example shown in FIG. 5, this is the definition that Ayn Rand gives to the word “selfishness” and how it is used throughout the book to convey and expand on every ideology and thought therewithin. Thus, this excerpt from a page in The Virtue of Selfishness would function as the introduction of the corresponding visual Book Preview: “The meaning ascribed in popular usage to the word ‘selfishness’ is not merely wrong; it represents a devastating intellectual ‘package deal,’ which is responsible, more that any other single factor, for the arrested moral development of mankind.” Along with the script, which is narrated, there is a visual of Ayn Rand looking at the audience 660. This visual constitutes a photograph that fades into a city congested street scene with many passerbies who are very hurried, as is usually the situation in Manhattan.

After this visual is observed by the online customer, there is shown the text extracted from the book jacket 620, stating “Ayn Rand here sets forth the moral principles of Objectivism. The philosophy that holds man's life-the life proper to a rational being as the standard of moral values and regards altruism as incompatible with man's nature, with the creative requirements of his survival, and with a free society.” It will be appreciated that this section of the Book Preview sets forth the book's focus and motives. This section elucidates the plot and informs the customer what the book is about. It has been found that there preferably is minimal use of the abstract in this section unless the director has decided that it should be presented visually. It is within the teachings of the present invention that, in all aspects of the visual content, abstractions may be included so long as the abstractions are deemed to be appropriate and compatible with the genre of the book.

Still referring to FIG. 5, the next section deals primarily with the acclaim 630 that the book has received—whether it is on a small or large scale. As will readily be appreciated by those skilled in the art, it corresponds to the recommendation section of the Book Preview. Obviously, this is where all of the “Thumbs Up!” comments belong. There are also appropriate visuals to these or alternative forms of documented acclaim. An example of an alternative form of documented acclaim would be a University of Texas Professor of Physics proclaiming that “this is the most groundbreaking book in physics that she has ever seen.” This accolade would preferably be accompanied with an appropriate visual of the professor standing near laboratory apparatus during an experiment. After the conclusion of the acclaim, a screen would be displayed 700 with the title of the book and the publisher arising in dramatic fashion. This, of course, is to remind the customer viewing the visual Book Preview of the title and publisher of the book. Then, the customer is shown the site that displays all of the Book Previews of the bookseller's screen which then gives the customer the option to go back to the bookseller home page 710, buy the book 720, or view another Book Preview 730.

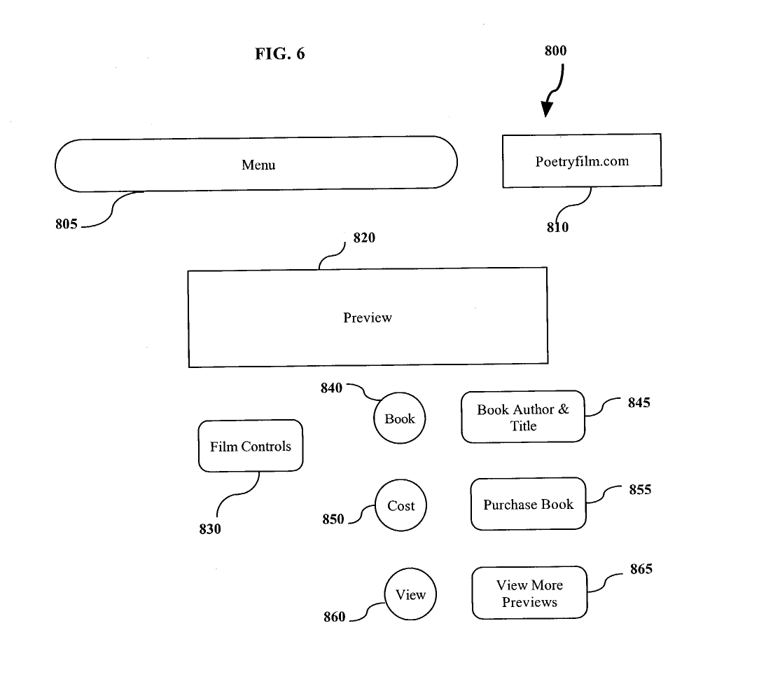

FIG. 6 depicts a sample screen layout 800 of an online bookseller's Web site wherein visual Book Previews may be invoked and viewed by customers. This screen entitled “Poetryfilm.com” 810 illustrates what the online bookseller's customer would see after pressing the icon to trigger viewing a visual Book Preview. It will be understood that this is the Web page that has the movie player with conventional VCR-like controls 830. According to the present invention, the customer would press icon 840 for the book 845 and then the corresponding Book Preview is played. When the Book Preview is completed, the customer has the option 850 to purchase the book at Amazon 855 or to press the movie projector icon 869 view more Book Previews 865. To view more Book Previews, the user/customer would go to the Home page and start from there or would click on the icon and it would take the user directly to a list of Book Previews that are available to browse. It would have a section for requests as well as searching with keywords. If the customer would like to purchase the book, the customer would be directed back to the bookseller's website and then proceed to purchase the book through the established procedure already prepared by the bookseller.

It will be understood that the present invention may be used for trade show presentations, email newsletters, Website promotions, upon or in conjunction with film-viewing sites devoted to or in part to Book Previews. For instance, embodiments of the present invention may be implemented in Book Preview email newsletters that are specifically targeted to existing or potential customers based on demographic and buying patterns delivered through email. In such email newsletters, consumers would be able to receive Book Previews in their email, enabling the customer base of publishers and booksellers to widen the reach of their existing marketing tools.

It should also be evident to those skilled in the art that embodiments of the present invention may comprise streaming media to display visual Book Previews contemplated hereunder. Of course, such Book Previews may also be implemented in conjunction with graphic design and animation applications to accomplish the advertising and promotional purposes hereinbefore described.

Other variations and modifications will, of course, become apparent from a consideration of the structures and techniques hereinbefore described and depicted. Accordingly, it should be clearly understood that the present invention is not intended to be limited by the particular features and structures hereinbefore described and depicted in the accompanying drawings, but that the present invention is to be measured by the scope of the appended claims herein.

What is claimed is:

1. In an environment in which a video producer creates a visual Book Preview video presentation to be used by an online bookseller for enabling a plurality of customers to engage in online browsing of said visual Book Preview advertising a book written by an author and published by a publisher, a system for creating said visual Book Preview comprising the steps of:
said online bookseller selecting a book to advertise online from a plurality of published books;
said producer acquiring the rights to produce said visual Book Preview about said selected published book from each of said author and said publisher;
said producer interviewing said author and said publisher to acquire a first-hand perspective and elemental montage of the background for the creation and publication of said selected book;
developing an overall interpretation and authorized implementation from said producer interview of said author and said publisher;
storyboarding said overall interpretation and authorized implementation;
developing a budget for said production of said visual Book Preview fr4om said storyboarded overall interpretation and authorized implementation;
obtaining production approval for said budget from said online bookseller;
managing said production of said Book Preview according to said budget and according to a time-line;
auditioning and selecting a cast of characters to be included in said visual Book Preview video;
shooting said video according to said storyboard and with said selected cast of characters;
editing said shot-video; and
then garnering said edited video with special effects to produce said specified visual Book Preview.

2. In an environment in which an online bookseller seeks to sell a plurality of published books to a plurality of online customers, a system for advertising said plurality of published books with a corresponding plurality of visual Book Preview video presentations, each said visual Book Preview of said plurality of visual Book Preview video presentations selected for a book of said plurality of published books comprising:
a combination of a textual portion and a related video portion for said selected book;
said textual portion obtained from preexisting textual description of said selected book;
said video portion including a confluence of the selected book author's perspective and the book publisher's perspective to engender a cultural perspective of said selected book;
said cultural perspective providing to each of said online customers realistic and accurate insight into the nature of said selected book; and
a means for each said online customer to reconcile said customer's perspective with said cultural perspective so that said customer may ascertain whether to engage in an online purchase of said selected book.

3. The visual Book Preview video presentations recited in claim 2 wherein said preexisting textual description is contained on a plurality of book jackets of said book.

4. The visual Book Preview video presentations recited in claim 2 wherein said video portion consists of a beginning, a climax, and a conclusion intended to inform said plurality of online customers about said selected book.

5. The visual Book Preview video presentations recited in claim 2 wherein said video portion consists of a beginning, a climax, and a conclusion intended to entice and entertain said plurality of online customers to engage in said online purchase of said selected book.

6. The visual Book Preview video presentations recited in claim 2 wherein said video portion consists of a short, active visual preview of said selected book that captures the personality and style of said author and said publisher as manifest by said visual Book Preview.

7. The visual Book Preview video presentations recited in claim 2 wherein each of said combinations of said textual portion and said video portion is convenient and easy-to-use for said plurality of online customers, and is designed to be expeditiously browsed in a time-efficient manner.
